(19) United States
(12) Patent Application Publication
(10) Pub. No.: US 2008/0223187 A1
(43) Pub. Date: Sep. 18, 2008

(54) PUNCH TOOL WITH VACUUM COLLECTION DEVICE

(76) Inventors: Amelia Leichliter, Palm Bay, FL (US); JoAnn Marrell, West Melbourne, FL (US); Joseph Kreuzpaintner, Orlando, FL (US); Brynn Johnson, Melbourne, FL (US)

Correspondence Address: GRAY ROBINSON, P.A., P.O. Box 2328, FT. LAUDERDALE, FL, 33303-9998, US

(21) Appl. No.: 11/685,841

(22) Filed: Mar. 14, 2007

(51) Int. Cl. B26D 7/06

(52) U.S. Cl. 83/100

(57) ABSTRACT

This invention is directed to a punch tool having a vacuum collection device for punching openings in the layers of insulation material used in the formation of MLI blankets, and automatically removing debris produced in such punching operation.

### FIELD OF THE INVENTION

This invention relates to an apparatus for punching multi-layer insulation material, and, more particularly, to a stationary or rotating punch tool having a vacuum collection device for removing debris produced during the punching operation.

### BACKGROUND OF THE INVENTION

Multi-layer insulation (“MLI”) blankets are currently used in a wide variety of space structures to protect components from thermal exposure. The blankets consist of a number of thin, individual layers of insulation material laid one on top of the other in a stack. The stack is formed with cut patterns, and in an overall shape, to meet the requirements of a particular structure.

The current method of manufacturing MLI blankets is a labor intensive process. Initially, the layers of insulation material are laid out, one atop the other, on a table or other surface. A polystyrene template formed in the desired shape and having the required cut patterns is then placed on top of the stack. An exact-o blade, scalpel, punch and/or other cutting tools are used to hand cut the overall shape and cut patterns in the stack, using the template as a guide.

The punched material produced in this process is free to “float” on the individual layers of MLI material, and in between the layers. Unattached material cannot be present in MLI blankets, and therefore such debris must be collected and removed manually with fingers, tweezers or the like. This is a time consuming, tedious and labor intensive process, and it is difficult to ensure that all of the debris will be collected in this manner.

### SUMMARY OF THE INVENTION

This invention is directed to a punch tool having a vacuum collection device for punching openings in the layers of insulation material used in the formation of MLI blankets, and automatically removing debris produced in such punching operation.

In the presently preferred embodiment, the punch tool of this invention is employed in an automated, programmable cutting apparatus which may include other cutting devices such as a drag blade and a wheel blade, all of which are mounted to a movable carriage above a vacuum table. A debris collection fitting in the form of a hollow tube is coupled to the punch tool by a spring or other suitable mounting means. One end of the debris collection fitting is formed with an inlet opening which receives the punch tool, and the opposite end of the debris collection fitting is formed with an outlet opening connected by a collection tube to a source of vacuum. The punch tool is formed with a passageway extending from its cutting tip into communication with the hollow interior of the debris collection fitting.

In operation, the punch tool is actuated (stationary or rotating) so that its cutting tip extends through the inlet opening of the debris collection fitting to punches holes in the stack of MLI layers. The source of vacuum is operated to create a negative pressure within the hollow interior of the debris collection fitting which draws debris produced in the course of the punching operation through the passageway of the punch tool, into the hollow interior of the debris collection fitting and then out of its outlet opening into the collection tube. Substantially all of the debris created by the punching operation is removed by the debris collection fitting, thus eliminating, or at least greatly reducing, the need for manual collection and removal of the debris.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a schematic, perspective view of an automated cutting apparatus with which the punch tool of this invention may be used;

FIG. 2 is a perspective view of a portion of FIG. 1 depicting the punch tool and debris collection fitting coupled to one another by a spring;

FIG. 3 is an elevational view of the outlet end of the debris collection fitting coupled to a collection tube for removing debris; and

FIG. 4 is a schematic, cross sectional view of the punch tool and the inlet end of the debris collection fitting.

### DETAILED DESCRIPTION OF THE INVENTION

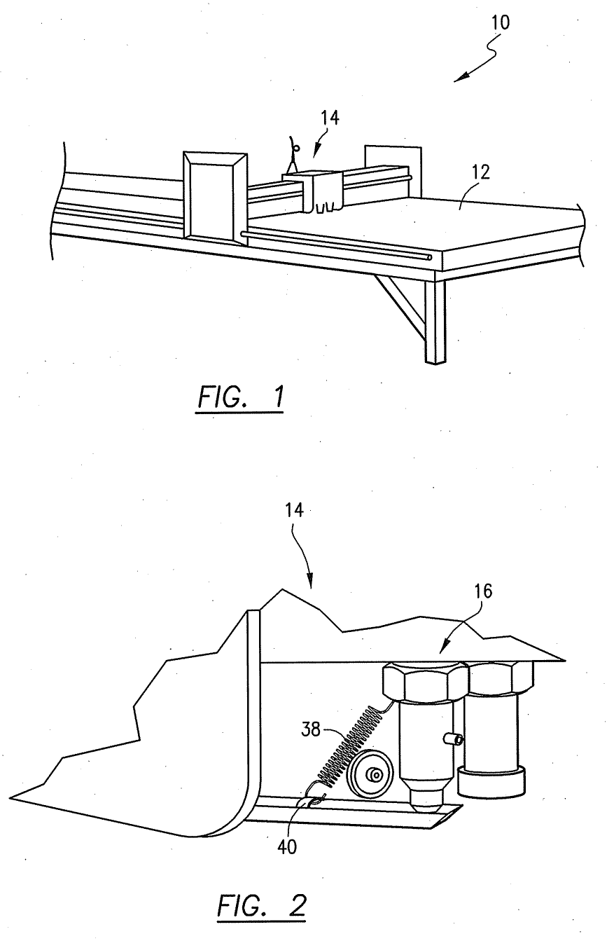

Referring initially to FIGS. 1 and 2, a cutting apparatus 10 is shown having a table 12 and a carriage 14 which is movable with respect to the table 12. The carriage 14 mounts a punch tool 16, and may include other cutting devices such as a drag blade and a wheel blade. The structural details of the cutting apparatus form no part of this invention and are therefore not discussed herein. Suitable cutting apparatus for use with the punch tool 16 of this invention include Eastman Model No. M9000 commercially available from the Eastman Machine Company of Buffalo, N.Y. and Gerber Model DCS 1500 commercially available from Gerber Technology in Tolland, Conn.

As best seen in FIGS. 2 and 4, the punch tool 16 is connected by an adaptor 18 to a head 20 coupled to the carriage 14 of the cutting apparatus 10. The punch tool 16 is retained within the adaptor by a set screw 22, and a second set screw 24 secures the adaptor 18 within the head 20. The lower end of the punch tool 16 is formed with a cutting tip 26, and the cutting tip 26 has a passageway 28 as shown in FIG. 4. The punch tool 16 is rotatable, and reciprocates in a vertically upward and downward direction, in the orientation depicted in the Figs.

As noted above, the cutting apparatus 10 may be employed in the manufacture of MLI blankets but it has been found that the punch tool of such devices, or hand-operated punch tools, produce debris which must be removed in a time-consuming and tedious hand operation. In order to overcome that problem, the punch tool 16 is combined with a debris collection fitting 30. The fitting 30 is preferably a length of tubing having a hollow interior 32, an inlet opening 34 and an outlet opening 36, both of which connect to the hollow interior 32. It should be understood that the term “tubing” as used herein refers to essentially any cross sectional shape, e.g. round, rectangular, square, etc., having one or more walls and a hollow interior. The tubing may be made of copper or other suitable material.

The fitting 30 is preferably retained against the head 20 by a coil spring 38, or other suitable mounting device, such that the cutting tip 26 of the punch tool 16 is received within the inlet opening 34 of the fitting 30. In this position, the passageway 28 formed in the cutting tip 26 of the punch tool 16 communicates with the hollow interior 32 of the fitting 30. A clip 40 may be provided on the wall of the fitting 30 to receive one end of the spring 38, as shown in FIG. 2.

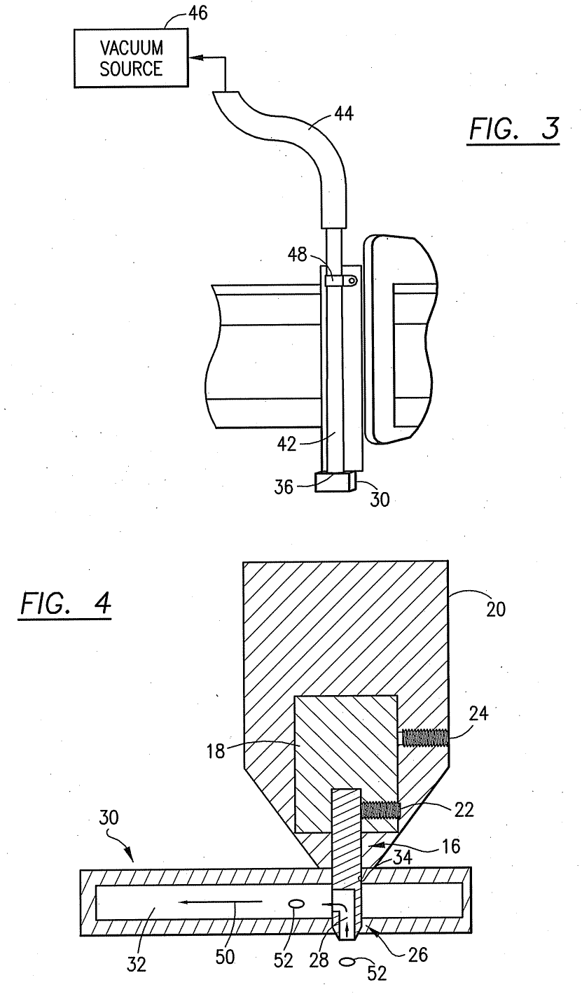

Referring now to FIG. 3, a view of the outlet end of the fitting 30 is illustrated. In the presently preferred embodiment, one end of a collection tube 42 formed of plastic or other suitable material is connected to the outlet opening 36 of the fitting 30 and its opposite end is coupled to a hose 44 or the like which communicates with a source of vacuum, represented by block 46 in FIG. 3. The tube 42 may be secured to the carriage 14 of the cutting apparatus 10 by one or more straps 48 or other connector(s).

The combination of the punch tool 16 and debris collection fitting 30 of this invention substantially eliminates the tedious and time consuming operation of hand cleaning of debris from the layers of an MLI blanket following a punching operation. The cutting apparatus 10 is operative to position the punch tool 16 at desired locations relative to layers of MLI material (not shown) placed on the table 12, and then reciprocate the punch tool 16 to form desired cut patterns in such layers. The vacuum source 46 is effective to apply a negative pressure within the hollow interior 32 of the fitting 30 thus creating a flow of air along a flow path extending from outside of the fitting 30, into the passageway 28 of the cutting tip 26 of the punch tool 16, through the hollow interior 32 of the fitting 30 and then out of the outlet opening 36 into the collection tube 42. See arrows 50 in FIG. 3. Debris 52 produced during the course of a punching operation is entrained within this flow of air thus removing it from the MLI layers without the need for hand operations.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. Apparatus for cutting a substrate, comprising:
a punch tool movable relative to the substrate;
a debris collection fitting coupled to said punch tool, said debris collection fitting having an inlet opening, an outlet opening and a hollow interior communicating with said inlet and outlet openings;
said punch tool being received within said inlet opening of said debris collection fitting and being movable into contact with the substrate thus producing debris;
a collection tube coupled to said outlet opening of said debris collection fitting and being adapted to communicate with a source of vacuum, whereby a negative pressure is produced within said interior of said debris collection fitting which draws debris into said inlet opening, through said hollow interior and out said outlet opening into said collection tube.

2. The apparatus of claim 1 in which said debris collection fitting is connected to said punch tool by a spring.

3. The apparatus of claim 1 in which said punch tool has a cutting tip formed with a passageway, said passageway being received within said hollow interior of said debris collection fitting to form a flow path for debris produced during a cutting operation from the substrate through said inlet opening into said hollow interior of said debris collection fitting.

4. The apparatus of claim 3 in which said passageway formed in said cutting tip of said punch tool terminates within said hollow interior of said debris collection fitting.

5. Apparatus for cuffing a substrate, comprising:
a punch tool moveable with respect to the substrate, said punch tool having a cutting tip formed with a passageway;
a debris collection fitting having an inlet opening, an outlet opening and a hollow interior communicating with said inlet and outlet openings, said punch tool being received within said inlet opening of said debris collection fitting so that said passageway in said cutting tip of said punch tool communicates with said hollow interior of said debris collection fitting;
a collection tube coupled to said outlet opening of said debris collection fitting and being adapted to communicate with a source of vacuum, whereby a negative pressure is produced within said interior of said debris collection fitting which draws debris produced by said punch tool into said passageway of said cutting tip of said punch tool, through said inlet opening of said debris collection fitting, through said hollow interior of said debris collection fitting and out said outlet opening thereof into said collection tube.

6. The apparatus of claim 5 in which said debris collection fitting is connected to said punch tool by a spring.
